(19) United States
(12) Patent Application Publication
(10) Pub. No.: US 2026/0063829 A1
(43) Pub. Date: Mar. 5, 2026

(54) LENS WITH ANTI-REFLECTION STRUCTURES

(71) Applicant: HEPTAGON PHOTONICS PTE. LTD., Singapore (SG)

(72) Inventors: Hongyuan LIU, Singapore (SG); John VIDALLON, Singapore (SG); Lope Vallespin PEPITO, JR., Singapore (SG); Anh Chien NGUYEN, Singapore (SG); Han Nee NG, Singapore (SG)

(21) Appl. No.: 19/383,259

(22) Filed: Nov. 7, 2025

Related U.S. Application Data
(63) Continuation of application No. PCT/SG2024/050413, filed on Jun. 21, 2024.

(30) Foreign Application Priority Data
Jun. 26, 2023 (DE) 10 2023 116 763.4
Aug. 30, 2023 (DE) 10 2023 123 362.9

(51) Int. Cl. G02B 1/118; B29D 11/00; G02B 1/04; G02B 1/111; G02B 1/12; G02B 13/00

(52) U.S. Cl. CPC G02B 1/118; B29D 11/00442; B29D 11/00865; G02B 1/041; G02B 1/111; G02B 1/12; G02B 13/0055; G02B 13/0085; G02B 13/008

(57) ABSTRACT

The present disclosure relates to an optical element (200) comprising: a lens element (202) configured to implement a lens function, wherein the lens element (202) comprises an epoxy material; and an additional epoxy layer (204) disposed on an optical surface (208) of the lens element (202), wherein the additional epoxy layer (204) includes anti-reflection structures (206) formed in the additional epoxy layer (204).

### TECHNICAL FIELD

The present disclosure relates generally to an optical element including a lens with anti-reflection structures, and to methods thereof (e.g., a method of fabricating an optical element).

### BACKGROUND

In general, optical elements to manipulate light are a key part in various types of devices such as sensors, cameras, display devices, medical equipment, and the like. In particular, optical lenses allow shaping a light beam according to a desired application, e.g. to focus the light beam towards a particular direction, to collimate a light beam for uniform light emission, etc. In view of the constant trend towards miniaturization, wafer-level optics is a technique for fabricating miniaturized optical elements, such as wafer-level lenses. Wafer-level optics may illustratively describe the use of techniques typical of the semiconductor industry for manufacturing optical elements. Wafer-level optics is commonly exploited for camera modules, e.g. for integration in portable devices such as tablets, smartphones, and the like. Improvements in optical elements, and in particular in optical elements fabricated via wafer-level manufacturing, may thus be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A shows an imaging device in a schematic view, according to various aspects;

FIG. 1B shows a lens including anti-reflection structures in a schematic representation, according to various aspects;

FIG. 1C and FIG. 1D show possible defects of a lens including anti-reflection structures;

FIG. 2A shows an optical element in a schematic representation, according to various aspects;

FIG. 2B and FIG. 2C show exemplary anti-reflection structures, according to various aspects;

FIG. 2D shows an optical element in a schematic representation, according to various aspects;

FIG. 2E shows a microscope picture of an optical element, according to various aspects;

FIG. 3 shows an optical stack including a plurality of optical elements in a schematic representation, according to various aspects;

FIG. 4 shows a schematic flow diagram of a method of fabricating an optical element, according to various aspects; and

FIG. 5 shows an illustrative representation of a method of fabricating an optical element, according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., an optical element, an optical stack, an imaging device). However, it is understood that aspects described in connection with methods may similarly apply to the devices, and vice versa.

In general, imaging devices capable of capturing three-dimensional (3D) information within a scene are of great importance for a variety of application scenarios. A prominent example is the use of tracking sensors for augmented reality (AR) and virtual reality (VR) applications. For example, a world-tracking sensor allows sensing the environment around the user wearing the sensor, and further allows sensing where the user is heading (e.g., similar to head-tracking). As another example, a gesture-tracking sensor allows sensing where the user's fingers and hands are, and in which form they are moving. As a further example, an eye-tracking sensor allows sensing where exactly the user is looking at and what the user is focusing on. Sensing data from the tracking sensors enable a variety of functionalities in the AR- and VR-context, such as presenting information to the user, executing commands based on a gesture or a gaze of the user, and the like. Other fields of application may include face recognition and authentication in modern smartphones, factory automation for Industry 5.0, authentication systems for electronic payments, internet of things (IoT) environments, and the like.

Tracking sensors for augmented reality and/or virtual reality may be camera based visual sensors operating in the visible spectral bandwidth and/or near infrared (NIR) spectral bandwidth, in view of the human sense of sight. An imaging device for such applications may usually include a compact camera module (CCM) for sensing light and generating corresponding sensing data. With the advancements of new generations of imaging devices, there is a constant demand for a miniaturization of their mechanical, optical, and electrical components.

In this context, a camera-based tracking sensor may usually include a CMOS image sensor (CIS), where CMOS stands for Complementary Metal-Oxide Semiconductor. The desirable properties for a CMOS image sensor may include a reduced (global shutter) pixel size, an increased quantum efficiency, e.g. in the NIR spectral bandwidth, and a simple integration in an integrated circuit, which may allow obtaining a reduced chip size and a reduction in costs. A camera-based tracking sensor may further include an optical lens module to collect light from the field of view of the sensor and direct the collected light to the image sensor (e.g., the CMOS image sensor). In this context, an important property for the optical module are anti-reflection capabilities. Illustratively, anti-reflection may describe the capacity of the optical module to reduce or prevent light reflection at the optical module (e.g., at a lens surface), thus improving the transmission or absorption of light from wide angles of incidence.

In the recent years, anti-reflections structures (e.g., nanostructures or microstructures) have emerged as a promising solution to increase light transmission/absorption in small-footprint optical components. Compared to conventional anti-reflective coatings, e.g. based on stacks of thin layers of different refractive indices, an approach based on surface structuring provides a gradation of refractive index to suppress reflection. Anti-reflection structures may operate in a wider range of wavelengths and for wider angles of incidence compared to layer-based anti-reflective coatings.

In the context of small-footprint systems, there is a growing demand for high-performance wafer-level optics (WLO) epoxy lenses with anti-reflection function, driven by the need for reliable and high quality optical component in various applications, e.g. micro-camera lenses for AR/VR. As the use of surface mounting technology (SMT) assembly in electronics manufacturing continues to expand, the demand for epoxy lenses with reflowability is increasing due to its cost-effectiveness, efficiency, and ability to share common equipment and production line.

However, thin film based anti-reflection coatings (ARC) do not work on epoxy lenses due to the mismatch in coefficient of thermal expansion (CTE), which may result in stress-induced wrinkles and cracks on the lens surface during the reflow process. To overcome this challenge, one solution is to fabricate anti-reflection structures (ARS) using an etching process, which results in a moth-eye nano-structure on the epoxy surface. This nano-structure gradually changes the refractive index of light passing from air into the lens surface, reducing the amount of light that is reflected at the surface and improving optical performance by reducing glare and improving image contrast.

However, it is important to note that the performance of the ARS is highly dependent on the topology of the nano-structures and the etchability of the substrate epoxy material. In order to achieve low reflectance over a broad wavelength range (e.g., visible and near-infrared), the nano-structures should ideally have a height in the range from 200 nm to 300 nm. However, for some epoxy materials achieving this desirable height can be challenging, due to their relatively lower etchability. As a result, when using epoxy-based lenses with ARS the occurrence of wrinkles may be observed, and a drift in reflectance after the reflow oven test may occur. Due to the drift, the reflectance may fall out of the specifications and no longer meet the requirements of anti-reflection function. A known solution is a method for fabricating moth-eye nanostructures on a photo-curable non-epoxy polymer using oxygen ion-beam etching. However, this method is limited as it cannot be used with non-etchable epoxy materials.

The present disclosure is related to a strategy for providing anti-reflection structures even on lenses (e.g., epoxy-based lenses) that have a relatively low etchability. In particular, the present disclosure may be based on the realization that an additional layer (e.g., a conformally formed layer) may be provided on the surface of the lens, and the additional layer may serve as host-substrate for forming the anti-reflection structures. The additional layer may be selected to have sufficient etchability (e.g., greater than an epoxy material of the lens) to allow forming anti-reflection structures of suitable height (e.g., in the range from 200 nm to 300 nm) to operate in a wide wavelength range and in a wide range of angles of incidence.

Illustratively, the present disclosure may be based on the realization that rather than forming anti-reflection structures directly on the lens surface, the anti-reflection structures may be formed in an additional layer dedicated to hosting the anti-reflection structures. This configuration may allow tailoring the properties of the additional layer with greater flexibility compared to the properties of the lens (which should satisfy stricter requirements to provide the desired optical function). In the proposed configuration, the properties of the additional layer may thus be flexibly adapted to ensure adhesion to the lens surface on the one hand, and to enable fabrication of anti-reflection structures with a desired geometry on the other hand.

According to various aspects, an optical element may include: a lens element configured to implement a lens function; and an epoxy layer disposed on an optical surface of the lens element, wherein the epoxy layer includes anti-reflection structures formed in the epoxy layer. In the optical element described herein the additional epoxy layer may be adapted to have good etchability properties that allow forming anti-reflection structures of sufficient height, thus introducing additional degrees of freedom in the fabrication of the optical element to tailor the properties to achieve a desired optical function.

In a corresponding manner, a method of fabricating an optical element may be provided, the method including: providing a lens element configured to implement a lens function; providing an epoxy layer on an optical surface of the lens element; and forming anti-reflection structures in the epoxy layer. In a preferred configuration, the fabrication of the optical element may include wafer-level optics techniques, e.g. the optical element/lens element may be fabricated via wafer-level optics manufacturing. As mentioned above, wafer-level optics techniques allow fabricating optical elements with a reduced footprint, which is of particular relevance in nowadays devices (e.g., sensors for AR/VR, smartphones, tablets, etc.). It is however understood that, in principle, the aspects described herein may also apply in a corresponding manner to an optical element/lens element fabricated via other types of techniques known in the art.

In a preferred configuration, the lens element may include or may be made of an epoxy material, e.g. an epoxy material with lower etchability compared to the epoxy material of the additional epoxy layer. An epoxy-lens or epoxy-based lens may be the most relevant use case for the strategy described herein, since epoxy materials are commonly used in wafer-level fabrication and, in general, for providing small-footprint lenses or other types of optical elements. It is however understood that, in principle, the additional epoxy layer in which the anti-reflection structures are formed may also be provided on lens elements including or made of different types of materials (e.g., glass, a polymer, and the like).

The term “epoxy” may be used herein as commonly understood in the art to describe a thermosetting polymer that includes epoxide groups. The term “epoxy” may be used herein to refer both to the “uncured” state (or non-hardened state) and the “cured” state (or hardened state, or cross-linked state) of the material. In some aspects, the term “epoxy resin” may be used to refer to the material in its “uncured” state. The epoxy may go from the “uncured” state to the “cured” state by means of a treatment that causes a cross-linking of the polymer chains. Illustratively, an epoxy resin may harden via chemical reactions that may be induced via a heat treatment or ultraviolet (UV) radiation, or by combining the epoxy resin with other components (illustratively, with a “hardener”). The term “epoxy layer” may be used herein to describe a layer that substantially consists of epoxy material, e.g. a layer made of epoxy material by more than 50% by volume, or by more than 70% by volume, or by more than 90% by volume, or by more than 99% by volume. An “epoxy layer” may include a single epoxy material or a combination (a mixture) of epoxy materials.

In a corresponding manner, a lens element that includes an epoxy material may include a single epoxy material or a combination (a mixture) of epoxy materials. In some aspects, the lens element may consist of epoxy, i.e. the material of the lens element may include substantially only epoxy, either a single epoxy material or a combination of epoxy materials with negligible presence of other components (e.g., impurities). In other aspects, the lens element may include an epoxy material or a combination of epoxy materials in a composition that further includes additional components in a non-negligible amount. The additional components may be non-epoxy and may be selected to tailor the properties of the lens, e.g. in terms of optical properties, robustness, flexibility, and the like.

According to various aspects, the present disclosure may thus provide a method for producing anti-reflection structures (ARS) on base epoxy materials with low etchability by applying a conformal layer of epoxy material with high etchability (illustratively, higher etchability compared to the material of the lens). The conformal layer exhibits good adhesion to the base epoxy material of the lens, while the ARS is formed on the outer surface of the conformal layer. The resulting structure is reflowable, and exhibits good anti-reflection performance, meeting the desired specifications.

In some aspects, the present disclosure also specifies a manufacturing process for producing the conformal layer using a wafer-level optics (WLO) replication process. Specifically, WLO techniques may be used to achieve the desired thickness of the conformal layer, typically ranging from a few μm (micrometer) to tens of μm, (although not limited to this range). The resulting conformal layer, with its high etchability and good adhesion to the base epoxy material allows for the formation of high-quality ARS on epoxy lenses, thereby improving their optical performance and reliability. The conformal layer of epoxy with high etchability may be produced using WLO replication process with high accuracy.

In the context of the present disclosure particular reference may be made to applications of an optical element configured as described herein for light detection purposes. Illustratively, particular reference may be made to a use of the lens for receiving light and focusing light onto an image sensor (e.g., a CMOS sensor). This application may be a relevant use case for the proposed optical element, e.g. in the context of AR- or VR-applications where the anti-reflection capabilities ensure collecting a greater amount of light, thus enhancing the sensing process or tracking process. It is however understood that in principle an optical element configured as described herein may also be used at the emitter-side of an optical system, e.g. to manipulate the emitted light.

An imaging device including the optical element may be integrated in a host device that exploits the imaging device to implement one or more functionalities (e.g., telecommunications, distance measurements, object tracking, and the like). Exemplary host devices for the imaging device may include a mobile communication device (e.g., a smartphone, a tablet, a laptop), a vehicle (e.g., a car), an automated machine (e.g., a drone, a robot), and the like.

In the present disclosure the term “lens element” is used to describe a lens that is part of an optical element and that is configured to implement a predefined lens function. A lens element may thus be configured to manipulate light passing through the lens element according to the corresponding lens function for which the lens element is designed. A lens element may illustratively be an optical surface configured (e.g., shaped) to define a predefined manipulation of the light. For example the predefined lens function may include focusing light, diffracting light, collimating light, diverging light, projecting a light pattern, etc. A “lens element” may also be referred to herein simply as “lens”. A “lens function” may be understood as an optical manipulation of light according to the lens type of the respective lens element (e.g., concave lens, convex lens, etc.).

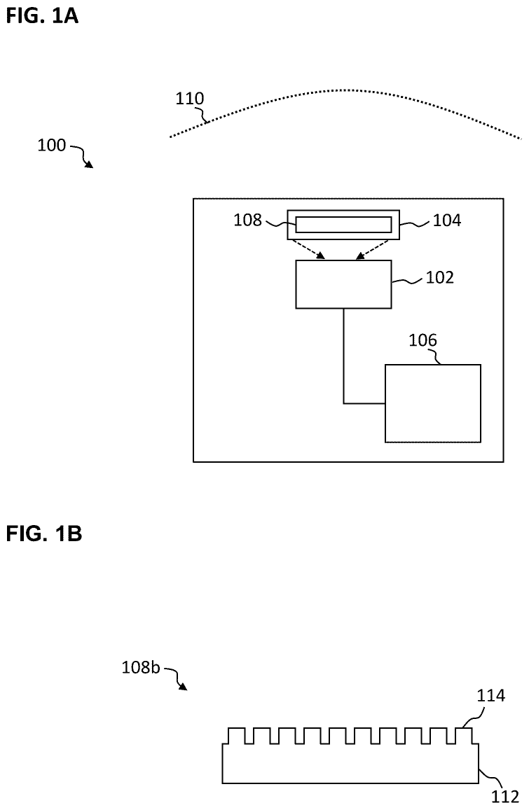

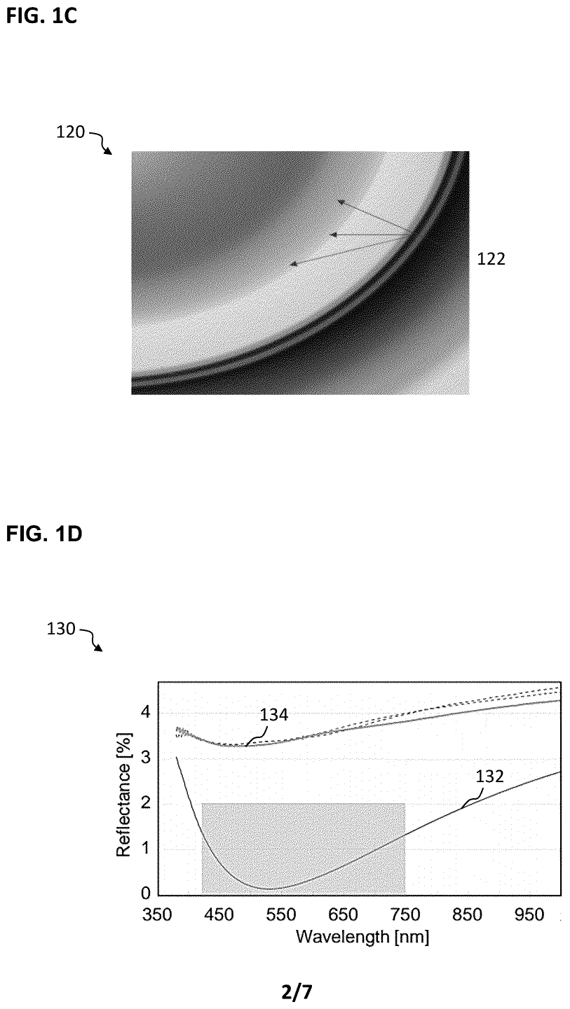

FIG. 1A shows an imaging device 100 in a schematic representation, according to various aspects. The imaging device 100 may be an exemplary device that includes one or more image sensors, e.g. for light detection, imaging, face recognition, and the like. It is understood, that the imaging device 100 provides an exemplary and simplified configuration of a possible application scenario of an optical element (or stack of optical elements) as described herein. In an exemplary configuration, the imaging device 100 may be a tracking sensor, e.g. the imaging device 100 may be configured to track one or more features (one or more elements) in a field of view 110 of the imaging device 100, as discussed in further detail below. As other examples, the imaging device 100 may be configured as a time-of-flight sensor, a proximity sensor, a stereo vision sensor, and the like. The representation of the imaging device 100 may be simplified for the purpose of illustration, and the imaging device 100 may include additional components with respect to those shown, such as one or more filters, one or more amplifiers, etc.

The imaging device 100 may include an image sensor 102. The image sensor 102 may be configured to be sensitive for light in a predefined wavelength range, e.g. the visible range (e.g., from about 380 nm to about 800 nm), infrared and/or near-infrared range (e.g., in the range from about 800 nm to about 5000 nm, for example in the range from about 820 nm to about 1200 nm, for example at 940 nm or around 940 nm), and/or ultraviolet range (e.g., from about 100 nm to about 400 nm). Illustratively, the image sensor 102 may be configured to convert light energy (illustratively, photons) of light impinging onto the image sensor 102 in electrical energy (e.g., in a current, illustratively a photo current). In general, the imaging device 100 may have compact dimensions, e.g. a small footprint size. For example, the image sensor 102 may be a chip-scale packaged image sensor.

The geometry (e.g., the shape and lateral dimensions) of the image sensor 102 may be adapted according to the system requirements, e.g. according to an overall dimension of the imaging device 100, according to fabrication constraints, etc. The image sensor 102 may thus have any suitable shape, such as a rectangular shape, a square shape, or even asymmetric shapes. In general, the image sensor 102 may include a plurality of pixels, e.g. a first plurality of pixels Nₓ defining a first dimension, and a second plurality of pixels N_{y} defining a second dimension. In various aspects, the image sensor may include a two-dimensional array of pixels. A number of pixels Nₓ, N_{y} in each direction, as well as a pixel pitch, may be adapted depending on the desired dimension of the image sensor 102. As a numerical example, the image sensor 102 may include at least 10⁴ pixels (e.g., 100×100 pixels), for example at least 4×10⁴ pixels (e.g., 200×200 pixels). As another numerical example, the image sensor 102 may have a lateral dimension (e.g., a width) in the range from 1 mm to 10 mm, for example in the range from 2 mm to 5 mm.

According to various aspects, the image sensor 102 may be configured according to CMOS-technology, e.g. the image sensor 102 may be a CMOS image sensor. In this configuration, the image sensor 102 may include a plurality of CMOS pixels, each including a photodetector that accumulates an electrical charge based on the amount of light impinging onto the photodetector. As another exemplary configuration, the image sensor 102 may be configured according to Charged Coupled Device (CCD) technology, e.g. the image sensor 102 may be a CCD image sensor. In this configuration, the image sensor 102 may include a plurality of CCD pixels with a photoactive region and a transmission region.

In the imaging device 100, an optical module 104 may define the field of view 110 of the image sensor 102. Illustratively, the optical module 104 may be configured to collect light and direct (e.g., focus) the collected light onto the image sensor 102, e.g. on one or more of the pixels of the image sensor 102. According to various aspects, the optical module 104 may include one or more optical elements 108 to focus the received light onto the image sensor 102. The image sensor 102 may be disposed in the image plane of the one or more optical elements 108.

The imaging device 100 may further include a processor 106 configured to receive image data from the image sensor 102 and carry out processing of the image data. For example, the processor 106 may be coupled with an analog-to-digital converter configured to convert an analog signal from the image sensor 102 (e.g., a photo current) into a digital signal to enable digital processing at the processor 106. The processor 106 may be configured to analyze and manipulate the image data according to the function provided by the imaging device 100.

As an example, the processor 106 may be configured to carry out a tracking of an element in the field of view 110. Illustratively, the processor 106 may be configured to follow an evolution of a spatial position of the element over time, e.g. to associate two-dimensional coordinates or three-dimensional coordinates corresponding to a position of the element to a respective time point. The tracked element may be any suitable feature or object of interest, such as the hand of a user, the eyes of a user, a vehicle, an animal, etc.

As another example, the processor 106 may be configured to calculate a time-of-flight associated with the received light. The processor 106 may receive a signal indicative of an emission time of the light and may identify a time of arrival of light at the imaging device 100 based on the signal delivered by the image sensor 102. This configuration may be provided, for example, for mapping the presence of objects in the field of view 110, and their properties such as distance from the device 100, speed, direction of motion, and the like.

As a further example, the processor 106 may be configured to determine (e.g., estimate, measure) the distortion of a predefined light pattern (e.g., a grid of light dots for example). This configuration may be provided, for example, for face-recognition applications, in which the distortion of the emitted pattern is associated to the profile of an object (e.g., a person) in the field of view 110 of the imaging device 100. For example, the processor 106 may be configured to reconstruct a shape of the object (e.g., a face) based on the distorted pattern.

In an exemplary configuration, the imaging device 100 may further include a light emission system (not shown) configured to emit light into the field of view 110. Illustratively, the light emission system may emit light in a field of illumination that overlaps (fully, or at least in part) with the field of view 110. The light emission system may include emitter optics (e.g., one or more lenses, one or more mirrors, and the like) and a light source configured to emit light in a predefined wavelength range. As an example, the light source may be or include a laser source, e.g. a Vertical Cavity Surface Emitting Laser (VCSEL) or a VCSEL-array. The light source may be configured to emit light having a predefined wavelength, illustratively in the same wavelength range or ranges for which the image sensor 102 is sensitive.

The light source may be configured to emit light in any suitable manner depending on the overall configuration of the imaging device 100. As an example, the light source may emit continuous light. As another example, the light source may emit light in a pulsed manner (e.g., for time-of-flight measurements), e.g. the light source may emit a sequence of light pulses. As a further example, the light emission system may emit light according to a predefined pattern, e.g. a grid of light dots. In an exemplary configuration, the processor 106 may be configured to control the light emission by the light source, e.g. the processor 106 may be configured to instruct or cause the light emission, e.g. at a certain time point, at certain time intervals, in response to a certain event, and the like.

As mentioned above, the optical module 104 may include an optical element 108, or a plurality of optical elements 108 (e.g., arranged in a stack), for manipulating light, e.g., for focusing light onto the image sensor 102. As shown in FIG. 1B, in an exemplary configuration an optical element 108b may in general include a lens portion 112 and anti-reflection structures 114 formed in the lens portion 112. The anti-reflection structures 114 suppress reflection at the lens, thus increasing transmission of light through the optical element 108b. In general, anti-reflection structures 114 are known in the art. However, as mentioned above, in a conventional design in which the anti-reflection structures 114 are directly formed in the surface of an epoxy lens, issues may occur after a reflow process, which is a typical process step in the fabrication of small-footprint imaging devices (e.g., optoelectronic devices). Illustratively, “reflow” may describe introducing a device (e.g., a circuit) in an oven to cause melting of the solder material (e.g., solder paste) and ensure a correct distribution of the solder material to contact the components of the device.

Possible issues occurring to anti-reflection structures formed in epoxy-based lenses are illustrated in FIG. 1C and FIG. 1D. As shown in the picture 120 in FIG. 1C, after reflow wrinkles 122 may appear on the surface of the lens. Furthermore, as shown in the graph 130 in FIG. 1D, a drift in the reflectance may occur. Illustratively, the pre-reflow data 132 illustrate a suppression of the reflection in a desired wavelength range, e.g. a reflection close to 0%. However, the post-reflow data 134 show an increase in the reflection after reflow, e.g. up to 4%. These issues may be related to the fact that the epoxy materials commonly used for fabricating a lens element are not well suited for forming anti-reflection structures therein, e.g. in view of the relatively lower etchability. The resulting anti-reflection structures are thus not sufficiently robust to sustain a reflow process without suffering a degradation in their properties, e.g. in view of a variation in their overall shape, arrangement, and the like.

Therefore, the properties of the optical element may deteriorate following the reflow process, and may be unsuitable to meet the desired specifications. Therefore, a conventional approach may be unsuitable to provide lenses with anti-reflection structures in the context of miniaturized devices in view of the deterioration of the geometrical and optical properties of the structures following a reflow process typical of the production of miniaturized devices and optical components.

The present disclosure may be based on the realization that rather than forming the anti-reflection structures directly in the lens surface, the anti-reflection structures may be formed in an additional layer of a material that enables creating more robust structures. Illustratively, the properties of the material of the additional layer may be tailored having in mind the creation of anti-reflection structures rather than the optical function to be provided by the lens (e.g., focusing, collimation, and the like). This approach thus allows decoupling the anti-reflection capabilities from the capabilities of the lens itself, thus introducing an additional degree of freedom that allows optimizing the fabrication and the overall configuration of the anti-reflection structures.

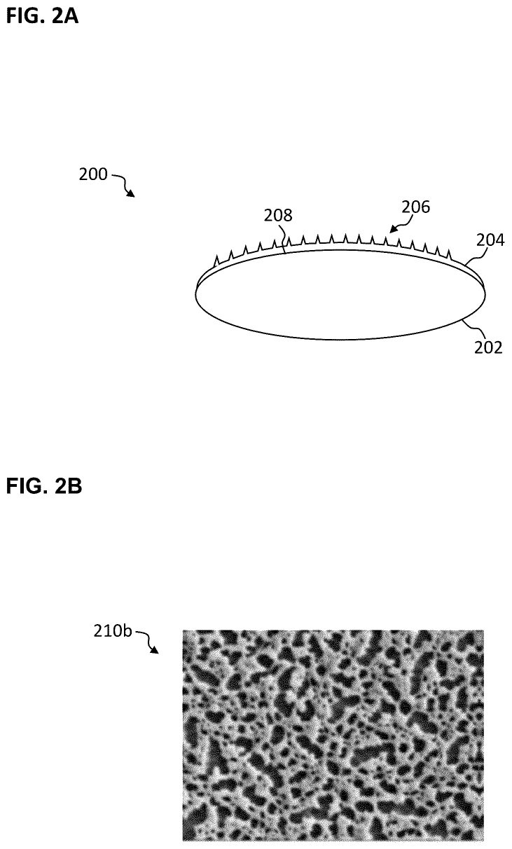

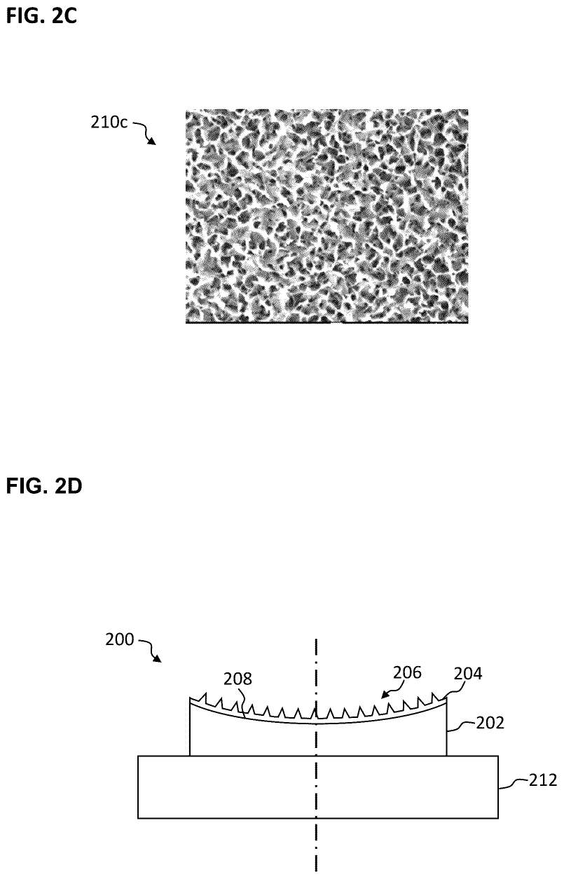

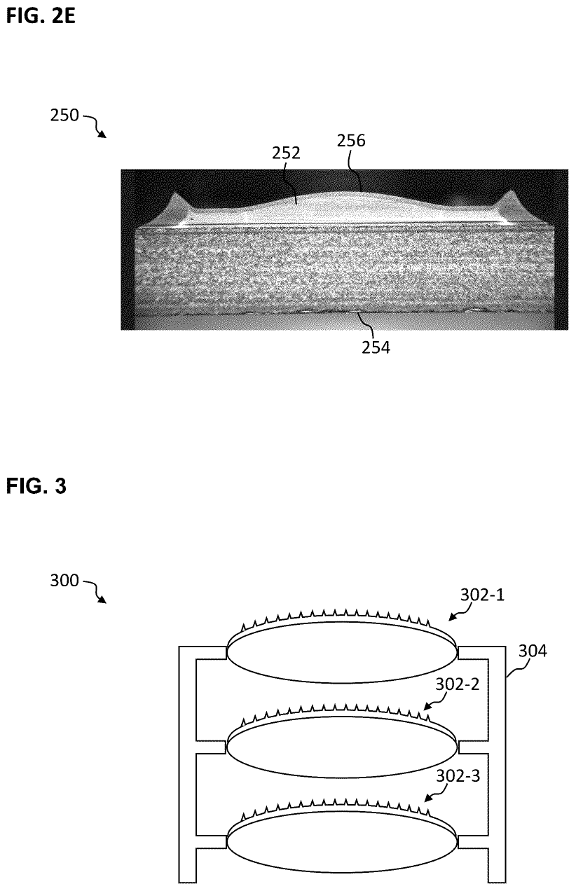

FIG. 2A shows an optical element 200 in a schematic representation, according to various aspects. The optical element 200 may be an adapted configuration of an optical element (e.g., the optical element 108) for use in an imaging device (e.g., the imaging device 100), e.g. as part of an adapted optical stack (see also FIG. 3). The optical element 200 may also be referred to herein as optical component 200.

In general, the optical element 200 may include a lens element 202 and an additional layer 204 disposed on the lens element 202 and in which anti-reflection structures 206 are formed. According to the configuration proposed herein, the anti-reflection structures 206 may thus be formed in an additional layer 204 dedicated to providing anti-reflection properties, rather than directly in the material of the lens element 202. As discussed above, this configuration may allow achieving more robust anti-reflection structures 206 by suitably selecting the properties of the material of the additional layer 204. In some aspects, the lens element 202 itself may be free of anti-reflection structures, which may be rather formed (only) in the additional layer 204.

In principle, the configuration proposed herein may be applied to any suitable type of lens element 202. In general, the lens element 202 may be configured to provide a lens function. Illustratively, the lens element 202 may be designed (e.g., shaped, dimensioned) to define a predefined manipulation of light passing through the lens element 202 according to the lens function. As examples, the lens element 202 may be a convex lens, a concave lens, a Fresnel lens, a microlens array, or any other type of lens that may benefit from the integration of an additional layer 204 with anti-reflection structures 206 formed therein. For example, in case of a microlens array, the additional layer 204 may be disposed on each microlens of the array.

As an exemplary configuration, the lens element 202 may include a (first) curved surface 208, e.g., a concave surface or a convex surface, e.g. defining a lens portion of the lens element 204. In this configuration, the additional layer 204 may be disposed on the (first) curved surface 208 of the lens element 202. For example, the lens element 202 may be configured as a plano-concave lens (see also FIG. 2D). In this configuration, the lens element 202 may include a planar (illustratively, flat) surface, and a concave surface. The lens element 202 may thus be a negative lens, illustratively a lens having a negative focal length. A plano-concave lens may be configured to provide beam expansion, e.g. may cause parallel input rays to diverge at the output side and may allow increasing the focal length of an optical system. In this configuration, the additional layer 204 may be disposed on the concave surface of the lens element 202.

As another example, the lens element 202 may be configured as a plano-convex lens. In this configuration, the lens element 202 may include a planar (illustratively, flat) surface, and a convex surface (illustratively, a spherical surface). The lens may thus be a positive lens, illustratively a lens having a positive focal length. A plano-convex lens may be configured to provide beam focusing, e.g. may cause parallel input rays to converge at the output side. In this configuration, the additional layer 204 may be disposed on the convex surface of the lens element 202.

In another exemplary configuration, the lens element 202 may include a further (second) curved surface disposed at an opposite side of the lens element 202 with respect to the first curved surface 208 (along the optical axis of the optical element 200). Illustratively, the curved surface 208 and the further curved surface may face towards opposite directions along the optical axis of the optical element 200. The further curved surface may be, for example, a convex surface or a concave surface, further defining the lens portion of the lens element 202. In this configuration, a further additional layer 204 may be disposed on the second curved surface.

The additional layer 204 may be an epoxy layer disposed on the (optical) surface of the lens element 202. Illustratively, the additional layer 204 may cover a main surface (or two main surfaces) of the lens element 202, e.g. may cover the surface(s) that extends in a direction perpendicular to the optical axis of the lens element 202. The additional layer 204 may also be referred to herein as functional layer or simply as epoxy layer.

Epoxy may be the material of choice for the additional layer 204 since it has been found that such type of material enables an efficient and reproducible fabrication of anti-reflection structures (e.g., via etching, or other suitable fabrication methods) that are capable of sustaining temperature treatments (e.g., reflow), while also providing suitable optical properties for combining the layer with a lens element. Furthermore, in the context of wafer-level processing, epoxy materials may be precisely disposed and patterned using well-established techniques, thus allowing the introduction of the proposed configuration in existing process flows without the need for extensive adaptations of the equipment or of the workflow. Possible materials for the epoxy layer 204 will be discussed in further detail below, e.g. in relation to the material of the lens element 202.

In general, the epoxy layer 204 may be disposed on the whole optical surface 208 (or surfaces) of the lens element 202 or at least on part of the optical surface 208. For example, the epoxy layer 204 may be disposed in a central portion of the optical surface 208, e.g. in a region centered around the optical axis of the lens element 202, e.g. a circular region, a square region, a rectangular region, an elliptical region, and the like. In another example, the epoxy layer 204 may be disposed on the entire optical surface 208 of the lens element 202, e.g. the epoxy layer 204 may fully cover the optical surface 208. In a corresponding manner, the anti-reflection structures 206 may be formed to cover the whole optical surface 208 (or surfaces) of the lens element 202 or at least part of the optical surface 208. For example, the anti-reflection structures 206 may be disposed in a central portion of the optical surface 208, e.g. in a region centered around the optical axis of the lens element 202, e.g. a circular region, a square region, a rectangular region, an elliptical region, and the like. Considering the exemplary case of wafer-level fabrication, the anti-reflection structures 206 be disposed in correspondence of the lens portion and not in correspondence of the yard portion of the lens element.

In principle, the epoxy layer 204 may be disposed on the surface 208 of the lens element 202 in any suitable manner that ensures adequate coverage and adhesion. According to various aspects, the epoxy layer 204 may be disposed to be in direct contact (e.g., direct physical contact) with the surface(s) 208 of the lens element 202. In a preferred configuration, the epoxy layer 204 may conformally formed (e.g., conformally deposited) on the surface 208 of the lens element 202. Illustratively, in various aspects, the epoxy layer 204 may be or define a conformal coating of the surface 208 of the lens element 202. A conformal deposition/coating ensures a strong adhesion to the lens surface, thus contributing to the robustness of the arrangement. Illustratively, the epoxy layer 204 may be an etchable conformal layer including the anti-reflection structures 206.

It is however understood that, in other aspects, the epoxy layer 204 may be disposed indirectly on the surface 208 of the lens element 202, e.g. the optical element 200 may include one or more intervening layers disposed between the surface 208 and the epoxy layer 204. The one or more intervening layers may be introduced to provide additional optical functionalities and/or to enhance the adhesion between the epoxy layer 204 and the lens surface 208. As an example, the optical element 200 may include an optical filter layer disposed between the surface 208 and the epoxy layer 204, e.g. to allow to pass through only light in a desired wavelength range. As another example, the optical element 200 may include an electrically insulating layer (e.g., a transparent oxide layer) disposed between the surface 208 and the epoxy layer 204, e.g. to enhance the adhesion of the epoxy layer 204 to the lens element 202.

The epoxy layer 204 may include anti-reflection structures 206 formed in the epoxy layer 204. In general, the anti-reflection structures 206 may be formed to be part of the epoxy layer 204 using any suitable technique. In a preferred configuration that may be readily integrated in wafer-level processing, the anti-reflection structures 206 may be etched in the epoxy layer 204. Illustratively, the epoxy layer 204 may undergo an etching process to realize anti-reflection structures 206 on its surface. It is however understood that the anti-reflection structures 206 may also be formed in the epoxy layer 204 via different types of structuring techniques, e.g., based on laser-machining, photolithography processes, wet-process deposition, wet-etch, nano-imprinting, and the like. The anti-reflection structures 206 may also be referred to herein as anti-reflective structures.

In general, the anti-reflection structures 206 may have any configuration suitable to provide anti-reflective properties, as known in the art. As known in the art, the anti-reflective properties may be tailored by controlling various parameters during the formation of the structures, such as size (e.g., in the nanometer range) for random porous type, aspect ratio (for rod/column type), and density (higher density means a more equivalent air “layer” that reduces the effective refractive index value of the whole structure). As known in the art, to achieve anti-reflection capabilities the anti-reflection structures 206 may be configured to provide a gradual change of refractive index, e.g. from the refractive index of a medium in which the optical element 200 operates (e.g., 1.0 for air) to the refractive index of the epoxy layer 204.

The anti-reflection structures 206 may be configured to provide anti-reflection in a predefined wavelength range, e.g. in the range in which a corresponding imaging device operates. For example, the anti-reflection structures 206 may be configured to provide anti-reflection for light in the visible range (e.g., from 380 nm to 800 nm) and/or in the near-infrared wavelength range (e.g., from 820 nm to 1200 nm, for example in a range centered around 940 nm), or in any other suitable wavelength range.

Providing “anti-reflection” for light in a certain wavelength range may be understood as the anti-reflection structures 206 being configured such that almost 100% of light with wavelength in that range that impinges on the optical element 200 (on the lens element 202) is transmitted through the optical element 200 (through the lens element 202), e.g. more than 99% of light with wavelength in that range, e.g. more than 98% of light with wavelength in that range. In a corresponding manner, providing “anti-reflection” for light in a certain wavelength range may be understood as the anti-reflection structures 206 being configured such that almost 0% of light with wavelength in that range that impinges on the optical element 200 is reflected away from the optical element 200 (from the lens element 202), e.g. less than 2% of light with wavelength in that range, e.g. less than 1% of light with wavelength in that range.

According to various aspects, the anti-reflection structures 206 may be anti-reflection nanostructures. The term “nanostructure” may be used herein as commonly understood in the art to describe an element having dimensions less than 1 micron. As numerical examples, an anti-reflection structure may have a (first) lateral dimension in the plane defined by the lens surface in the range from 50 nm to 500 nm, e.g. in the range from 100 nm to 200 nm. In an exemplary configuration, an anti-reflection structure 206 may have a (second) lateral dimension in the direction perpendicular to the surface (illustratively, a height) greater than the extension in the plane of the substrate (illustratively, a width, or a length, or a diameter). As a numerical example, an anti-reflection structure 206 may have a height in a range from 100 nm to 500 nm, e.g. in the range from 150 nm to 400 nm, e.g. in the range from 200 nm to 300 nm. It is however understood that in principle the aspects discussed herein may also be applicable to structures with larger dimensions, e.g. also larger than 1 micron, e.g. to anti-reflection microstructures.

As an example, a nanostructured anti-reflective surface may include an array of nanostructures, e.g. nano-pillars, nano-pyramids, stochastic cloudlets, sponge-like nanostructures, and/or the like. In an exemplary configuration, an array of nanostructures forming the nanostructured surface may have a sub-wavelength pitch, illustratively a sub-wavelength center-to-center distance between neighboring nanostructures. The design of the nanostructured surface may thus be adapted according to the intended application of the optical element 200, e.g. for imaging in the visible range, or near-infrared range, as examples. For example, the pitch may be smaller than the shortest wavelength in the predefined wavelength range associated with the operation of the optical element 200. As numerical examples, the pitch of the array of nanostructures may be in the range from 50 nm to 500 nm, for example in the range from 100 nm to 300 nm.

The anti-reflection structures 206 may thus have any suitable geometry and/or arrangement to provide anti-reflection capabilities in a desired wavelength range. As an example, the anti-reflection structures 206 may be or include pit-like features formed in the epoxy layer 204. As another example, the anti-reflection structures 206 may be or include rod-like features or spike-like features formed in the epoxy layer 204. As another example, the anti-reflection structures 206 may be or include moth-eye features formed in the epoxy layer 204.

In this regard, FIG. 2B and FIG. 2C show respective microscope pictures 210b, 210c of anti-reflection structures, e.g. exemplary configurations/realizations of the anti-reflection structures 206. The microscope picture 210b in FIG. 2B illustrates an anti-reflective structuring achieved by an etching process using plasma-assisted reactive gas in a low-pressure chamber (usually referred as “dry-etch”). FIG. 2B shows a typical ARS surface consisting of deep valley, pit features obtained from such process. The microscope picture 210c in FIG. 2C illustrates an anti-reflective structuring achieved by local break-down and dissolution via high temperature water treatment (could also be referred as “wet-etch”). FIG. 2C shows a typical nano-porous surface of the layer after the treatment process.

According to various aspects, the lens element 202 may include or may be made of any suitable material to implement the desired optical function. In general, the lens element 202 may include or may be made of a material that allows transmission of light in the predefined wavelength range in which the optical element 200 should operate (e.g., visible, near-infrared, etc.). In a preferred configuration, which is of particular relevance in the context of wafer-level fabrication, the lens element 202 may include or may be made of an epoxy material (e.g., different from the material of the epoxy layer 204). As other suitable examples, the lens element 202 may include or may be made of glass or an optical polymer material, e.g. a UV-curable polymer such as a thiol-ene based polymer, an acrylate resin, and the like. As a numerical example, the lens element may include or may be made of a material configured to have a transmission greater than 90% in the above mentioned wavelength ranges, for example a transmission greater than 94%.

In general, the material of the lens element 202 may have a lower etchability compared to the material of the epoxy layer 204. In general the “etchability” of a material may be expressed in various ways, for example as an amount of material etched away per unit time, or as number of pores formed per unit area. A first material having a “lower etchability” compared to another (second) material (with “greater etchability”) may thus indicate that the first material is etched less in the same amount of time and in the same etching conditions compared to the second material (which is thus etched more). For example, a lower amount of the first material is etched away compared to the second material during a same time period in the same etching conditions. As another example, less pores per unit area may be formed in the first material compared to the second material during a same time period in the same etching conditions.

In general, the (epoxy) material of the lens element 202 may have a lower etchability compared to the epoxy material of the epoxy layer 204 considering etching processes commonly used for the fabrication of optical elements, e.g. considering etching processes commonly used in wafer-level fabrication. As an example, the epoxy material of the epoxy layer 204 may have a greater etchability compared to the material of the lens element 202 considering a plasma-assisted etching process, e.g. an etching process based on a plasma formed with a combination of an inert gas (such as, for example, argon, helium, neon) and a reactive gas (such as oxygen or a fluorine-bearing gas such as chlorine trifluoride).

In the configuration in which the lens element 202 includes or is made of an epoxy material, the epoxy material of the lens element 202 may be different from the epoxy material of the epoxy layer 204, e.g. the epoxy material of the lens element 202 may have a lower etchability compared to the epoxy material of the epoxy layer 204. As an example, the lens element 202 may include or may be made of an optical epoxy material, e.g. the lens element may include an epoxy-based material, an acrylic-based material, or a cyclic olefin polymer based material.

The epoxy material of the epoxy layer 204 may be selected to allow forming robust anti-reflection structures 206, e.g. the epoxy material may be configured to allow forming anti-reflection structures 206 having a height of at least 200 nm in an efficient manner, while still allowing transmission of light (in the predefined wavelength range). As examples, the epoxy material of the epoxy layer 204 may be bisphenol-based, aliphatic-based or a combination of both.

According to various aspects, the epoxy layer 204 may have any suitable thickness to allow forming anti-reflection structures 206 therein. The “thickness” of the epoxy layer 204 may be the dimension of the epoxy layer 204 in the direction parallel to the optical axis of the optical element 200, e.g. the dimension in the direction perpendicular to the main surface of the lens element 202. As a numerical example, the epoxy layer 204 may have a thickness in the range from 1 μm to 100 μm, for example a thickness in the range from 5 μm to 50 μm.

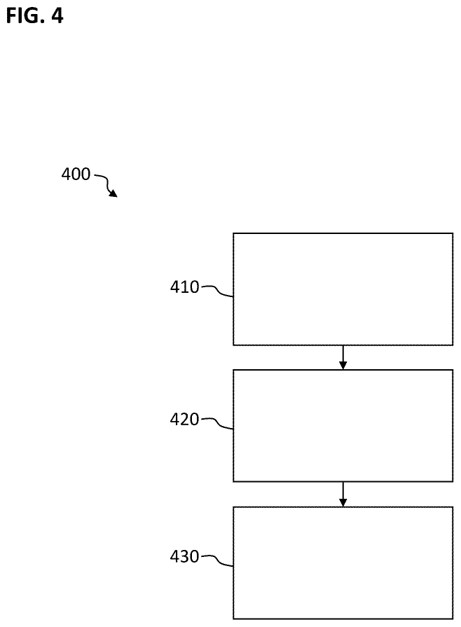

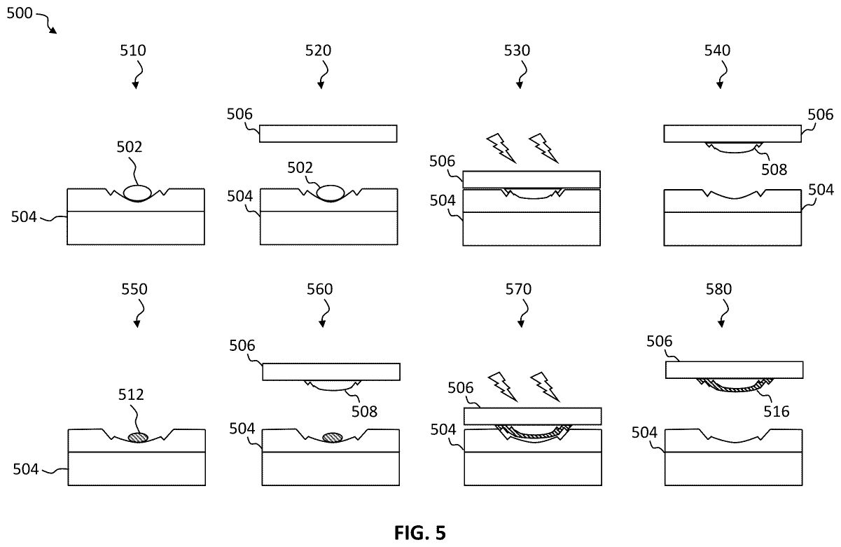

In a preferred configuration, the optical element 200 may be manufactured by wafer-level processing (see also FIG. 4 and FIG. 5). The term “wafer-level”, e.g. in relation to an optical element, an epoxy layer, or a lens element, may be used herein to indicate that the corresponding entity is fabricated/structured using wafer-level optics techniques, such as UV molding replication, lithography, etc. Wafer-level optics may be based on processes typical of semiconductor manufacturing, such as thin film deposition, lithography, etching, molding, imprinting, and the like. For example, in wafer-level optics, optical elements may be fabricated using molds, which enables mass production. As an abridged overview, wafer-level optics may include imprinting to fabricate optical components at the wafer-level, and then a layer by layer stacking of the individual optical components to assemble a final product. The resulting optical module may finally be coupled, e.g. bonded, with an image sensor (e.g., a CMOS image sensor) at the wafer-level. Wafer-level optics may thus allow producing optical modules with a reduced footprint compared to other fabrication techniques. Various aspects related to wafer-level processing will be described in further detail in relation to FIG. 4 and FIG. 5.

According to various aspects, as shown in FIG. 2D, the optical element 200 may further include an optical substrate 212, and the lens element 202 may be disposed on the optical substrate 212. For example, the optical substrate 212 may provide mechanical support to the lens element 202 for fabrication via wafer-level optics techniques.

The substrate 212 may include or may be made of any suitable refractive material, such as a glass (e.g., borosilicate glass or alumina borosilicate glass), optical filter glass, an epoxy, a polymer, or a PCB material (e.g., G10 or FR4), where PCB stands for Printed Circuit Board. In some aspects, the substrate 202 may be a wafer, e.g., a glass wafer, an epoxy wafer. As other examples, the substrate 212 may include or may consist of an oxide, a nitride, an oxynitride, and the like.

In general the substrate 212 may be configured to allow transmission of light, e.g. in the predefined wavelength range in which the optical element 200 operates. The substrate 212 may be transparent for light in the operating wavelength range of the optical element 200. Illustratively, the substrate 212 may be configured to allow light (with wavelength in the predefined range) to pass through. As an example, the predefined wavelength range may be the visible range, infrared and/or near-infrared range, or any other suitable range, as discussed above. As a numerical example, the substrate 212 may include or may be made of a material configured to have a transmission greater than 90% in the above mentioned wavelength ranges, for example a transmission greater than 94%. In some aspects, the optical substrate 212 may be configured to filter out light with wavelength outside the predefined wavelength range. For example, the material of the substrate 212 may be transmissive only in the desired wavelength range. As another example, the optical substrate 212 may have a coating configured to block light with wavelength outside the predefined wavelength range. In general, the dimensions of the optical substrate 212 may be adapted based on the desired use case, e.g. based on the overall dimensions of the optical element 200 or of the corresponding imaging device in which the optical element 200 is integrated.

In some aspects, the optical surface 208 of the lens element 202 on which the epoxy layer 204 is disposed may be facing away from the substrate 212. For example, the lens element 202 may have at least one planar surface disposed in contact with the substrate 212, and a curved surface on which the epoxy layer 204 is disposed. For example, the lens element 202 may have a plano-concave configuration (as shown in FIG. 2D), a plano-convex configuration, or any other suitable configuration for coupling with the substrate 212.

The dimensions of a lens element 204 (and/or of the substrate 212) may be adapted depending on the desired end-application of the optical element 200. As a numerical example, a thickness of the substrate 212 may be in the range from 50 μm to 1 mm, for example in the range from 200 μm to 700 μm. A thickness of the lens element 204 (e.g., a minimum thickness, at the edge or at the center depending on the lens type) may be in the range from 5 μm to 100 μm, for example in the range from 10 μm to 50 μm. As a further numerical example, a diameter of the lens element 204 (e.g., a diameter of the concave portion or convex portion) may be in the range from 100 μm to 10 mm, for example in the range from 500 μm to 1 mm.

FIG. 2E shows a microscope picture 250 of an optical element configured as described herein. In particular, the optical element in the exemplary configuration in FIG. 2E may include a lens element 252 disposed on an optical substrate 254 (e.g., a glass wafer), and an epoxy layer 256 may be conformally deposited on the lens element 252 to allow the structuring of anti-reflection structures.

As mentioned above, optical elements may be stacked together to provide an optical stack in which the type of optical elements (e.g., the type of lenses) and the order of their disposition may provide achieving a particular optical function for light manipulation, e.g. for focusing, collimating, and the like. FIG. 3 shows an optical stack 300 in a schematic representation, according to various aspects. In general, the optical stack 300 may include a plurality of optical elements, at least one of which is configured as described herein. For example, the optical stack 300 may be for use in an imaging device, e.g. in the imaging device 100 as optical element 108.

In the exemplary configuration in FIG. 3, the optical stack 300 may include a first optical element 302-1, a second optical element 302-2, and a third optical element 302-3. It is however understood that the optical stack 300 may include any suitable number of optical elements depending on the desired optical functionality, e.g. two, three, four, five, ten, or more than ten optical elements. Furthermore, for the purpose of illustrating the principles of the optical stack 300 the optical components 302-1, 302-2, 302-3 are shown as having the same configuration, e.g. the same lens element. It is however intended that each optical element may be configured to provide in combination with the other optical elements the target optical functionality. Thus, the lens elements of different optical elements 302-1, 302-2, 302-3 may be configured in the same manner, or in different manners (e.g., one may be a convex lens, one may be a concave lens, etc.) to achieve the target optical functionality.

Stated differently, each lens element 302-1, 302-2, 302-3 may be configured according to a respective lens function, and the individual lens functions may be selected to define in combination a target optical functionality. The first lens element 302-1 may be configured to implement a first lens function, the second lens element 302-2 may be configured to implement a second lens function, the third lens element 302-3 may be configured to implement a second lens function, etc. The first lens function may be equal to or different from the second lens function and/or third lens function. The second lens function may be equal to or different from the first lens function and/or third lens function, etc.

In general, at least one optical element 302-1, 302-2, 302-3 may be configured as proposed herein, e.g. according to any of the possible configurations discussed in relation to FIG. 2A to FIG. 2E. In some aspects, each optical element 302-1, 302-2, 302-3 may be configured as proposed herein, or a subset of optical elements 302-1, 302-2, 302-3 may be configured as proposed herein (e.g., more than one but not all optical elements). For example, at least (or, in some aspects, only) the optical element disposed at the outermost position in the optical stack 300 may include the epoxy layer with the anti-reflection structures. Illustratively, the outermost optical element may be the optical element closest to the field of view during an operation of the optical stack 300 (and corresponding imaging device).

In general, the optical elements 302-1, 302-2, 302-3 may be coaxially aligned with respect to one another. Illustratively, the optical elements 302-1, 302-2, 302-3 may be disposed (aligned) along the optical axis of the optical stack 300. The individual optical axes of the optical elements 302-1, 302-2, 302-3 may (fully) overlap with one another, illustratively the individual optical axes may be aligned with one another. Further illustratively, the optical elements 302-1, 302-2, 302-3 may be centered around the optical axis of the optical stack 300.

The stacking of the optical elements 302-1, 302-2, 302-3 may be carried out in any suitable manner depending on the individual configurations of the optical elements. In an exemplary configuration, as shown in FIG. 3, the optical stack 300 may include a support structure 304 in which the optical elements 302-1, 302-2, 302-3 are accommodated. The support structure 304 may illustratively provide or define a spacing between adjacent optical elements 302-1, 302-2, 302-3 in the stack

The support structure 304 may provide structural support to the lens stack. Furthermore, the dimensions (e.g., the height or spacing between optical elements 302-1, 302-2, 302-3) of the support structure 304 may be selected to facilitate the adaptation of some properties of the optical stack 300, e.g. to adapt the lens to lens distance and accordingly the effective focal length of the optical stack 300. The support structure 304 may include or may be made of any suitable material, for example a polymer material or a glass material. For example a glass material may provide more robust mechanical and thermal stability of the optical stack 300.

In an exemplary configuration, the support structure 304 may include or may be made of an opaque material, e.g. opaque in the wavelength range in which the optical stack 300 operates. In another exemplary configuration, the support structure 304 may include or may be made of a transparent material, e.g. transparent in the wavelength range in which the optical stack 300 operates.

FIG. 4 shows a schematic flow diagram of a method 400 of fabricating an optical element. The method 400 may be related to the fabrication of the optical element 200 described in relation to FIG. 2A to FIG. 2E, and to the stacking of optical elements to form an optical stack (e.g., the optical stack 300 in FIG. 3). It is understood that the aspects described in connection with the optical element 200 or optical stack 300 may apply in a corresponding manner to the method 400, and vice versa. In general, the forming of the various parts of the optical element may be carried out with conventional techniques. In a preferred configuration, the forming of the various parts of the optical element may be carried out via wafer-level fabrication techniques (see also FIG. 5).

The method 400 may include, in 410, providing a lens element, e.g. forming a lens element. The lens element may be fabricated with any suitable technique and with any suitable material (e.g., glass, an optical polymer, epoxy, etc.). For example, considering wafer-level optics, the lens element may be fabricated via a master stamp designed according to the configuration (e.g., shape, size, etc.) of the lens element to be fabricated. The master stamp may allow transferring the desired pattern into a curable material, such as an optical polymer material or an epoxy material, which may then be cured via irradiation, for example with ultraviolet (UV) light. A suitable approach for wafer-level optics may include a so called “step-and-repeat ultraviolet imprint lithography”, in which individual molds for the lens elements are replicated on a substrate (e.g., a wafer) using high precision alignment. The stamp (e.g., the master stamp, or a corresponding working stamp) may define the shape of a curable material disposed on the substrate, and the subsequent irradiation (e.g., via UV light) may cure the material in the desired shape. Typical deposition methods may include puddle dispense or ink jet dispense.

Thus, in an exemplary configuration, providing the lens element may include disposing a material of the lens element in a replication tool. The replication tool may be shaped according to a target profile for the lens element. For example, the replication tool may have a replication site (or a plurality of replication sites for parallel fabrication) defining a curved surface, e.g. a convex surface or a concave surface. The material of the lens element may be for example an epoxy material as discussed in relation to FIG. 2A to FIG. 2E. Providing the lens element may further include curing the material of the lens element, for example via UV irradiation. In some aspects, providing the lens element may include contacting the replication tool with an optical substrate (e.g., a wafer, such as a glass wafer), and curing the material to form the lens element on the substrate.

After curing, further processing steps may be carried out to finalize the lens element. Such further processing steps may be carried out at the wafer-level, thus providing an efficient and streamlined procedure for the completion of the fabrication. The further processing steps may include, for example, de-molding, cleaning, polishing, edge removal, coating, and stacking. Wafer-level optics may include stacking the wafers including the individual optical components (or individual lens elements), e.g. via wafer bonding, to provide an optical stack having the desired number and arrangement of optical elements (as discussed in relation to FIG. 3). Wafer-level optics may further include dicing the wafer stack to provide individual optical modules, e.g. to be placed and coupled with an image sensor.

The method 400 may further include, in 420, providing an epoxy layer on an optical surface of the lens element. For example, the method 400 may include forming a conformal epoxy layer on the surface of the lens element. The epoxy material of the epoxy layer may have a greater etchability of the (epoxy) material of the lens element. As an example, providing the epoxy layer may include disposing (e.g., depositing) the epoxy material of the epoxy layer in the replication tool used for fabricating the lens element. The method 400 may further include contacting the replication tool with the lens element to distribute the epoxy material of the epoxy layer over the surface of the lens element. The method 400 may further include curing the epoxy material to form the epoxy layer on the optical surface of the lens element (e.g., via a heat treatment, e.g. via UV irradiation, as an example).

Any suitable technique known in the art may be used to define the thickness of the epoxy layer in a precise manner. Illustratively, any suitable deposition or replication technique may be used to form an epoxy layer having the desired thickness. In general, providing the epoxy layer may include causing the epoxy material of the layer to distribute over the optical surface of the lens element with the desired thickness, e.g. in a conformal manner.

The method 400 may further include, in 430, forming anti-reflection structures in the epoxy layer. As discussed above, the anti-reflection structures may have any suitable configuration to suppress reflection of light in a desired wavelength range (illustratively, an operating wavelength range of the optical element). In a preferred configuration, the method 400 may include etching the (additional) epoxy layer to form the anti-reflection structures in the epoxy layer. As other examples, the method 400 may include forming the anti-reflection structures via laser-machining, photolithography processes, wet-process deposition, wet-etch, or nano-imprinting.

An example of etching process to produce an anti-reflective structured surface, the method 400 may include using a plasma-assisted etching of the polymer-based surface (illustratively, the surface of the epoxy layer) in a low pressure (vacuum) chamber. This method is usually referred as “dry-etch”. The etching may include depositing an ultrathin metal oxide layer on the target polymer surface. Due to its incomplete coverage of the target surface, the metal oxide layer may serve as pseudo-mask for the etching process. The etching step may include a combination of plasma generated by an inert gas together with a reactive gas that would attack and remove part of the exposed polymer surface to generate a random morphological features (such as pits, valleys, columns etc.) at the nanometer scale. Illustratively, in some aspects, the method 400 may include carrying out a plasma-assisted etching of the epoxy layer. The plasma-assisted etching may include exposing the surface to be etched to an atmosphere including an inert gas combined with a reactive gas. As examples, the inert gas may be helium, neon, or argon. The reactive gas may be oxygen or a fluorine-bearing gas, such as chlorine trifluoride. Illustratively, the gas may be ionized and the ions may attack the epoxy and create the etched structure. When the ions attack the layer, they generate the anti-reflection structures, e.g. deep valleys, or some kind of rock-like structures, or more regular structures organized in an array.

Low reflectance of light may be achieved from the (nano-)structured polymer surface due to the mixing of surface material with regions of air at a sub-wavelength scale resulting in a gradual decrease of the effective refractive index.

FIG. 5 shows a method 500 of fabricating an optical element as described herein, in an illustrative representation according to various aspects. The method 500 may be an exemplary realization of the method 400 described in FIG. 4. It is understood that the method 500 illustrates processing steps that have been found suitable to obtain the configuration proposed herein, but also other types of processing steps may be provided.

The method 500 may include, in 510, disposing the material 502 to form a lens element on a replication tool 504 (also referred to as lens tool). The material 502 of the lens element may be for example a first epoxy material (e.g., with relatively low etchability). In the exemplary configuration in FIG. 5, the replication tool 504 may be structured to define a concave profile for the lens element. For example, the lens material 502 may be disposed on the replication tool 504 via epoxy jetting.

The method 500 may further include, in 520, bringing the replication tool 504 in contact with an optical substrate 506 (e.g., a glass wafer) to define the lens element on the surface of the substrate 506. As shown, the replication site in the replication tool 504 may also include a yard portion to allow an overflow of lens material 502 during the formation of the lens element. With the replication tool 504 in contact with the substrate 506 the method 500 may include, in 530, curing the lens material 502, e.g. via UV-curing, illustratively via irradiation with UV light (or any other suitable curing process depending on the material of the lens element). After curing, the method 500 may include, in 540, separating the substrate 506 from the replication tool 504 (e.g., a wafer separation), leaving the lens element 508 on the substrate.

After having formed the lens element 508 in the first part of the method 500, the second part of the method 500 may be related to forming the epoxy layer on the surface of the lens element. In this regard, the method 500 may include, in 550, disposing the epoxy material 512 of the epoxy layer in the replication tool 504 (illustratively, in the same replication site used for forming the lens element 508). For example, the epoxy material 512 may be deposited via epoxy jetting.

The method 500 may further include, in 560, bringing the replication tool 504 in contact with the optical substrate 506 in which the lens element 508 was formed. Illustratively, the contacting of the substrate 506 with the replication tool 504 may cause the epoxy material 512 to distribute on the lens element according to the desired thickness for the epoxy layer. As shown, the replication site in the replication tool 504 may also include a yard portion to allow an overflow of epoxy material 512 during the formation of the epoxy layer. With the replication tool 504 in contact with the substrate 506 the method 500 may include, in 570, curing the epoxy material 512, e.g. via UV-curing or any other suitable curing treatment. After curing, the method 500 may include, in 580, separating the substrate 506 from the replication tool 504 (e.g., a wafer separation), leaving the epoxy layer 516 conformally formed on the lens element 508. Although not shown, the method 500 may further include forming anti-reflection structures (e.g., nanostructures) in the epoxy layer 516, for example via etching (e.g., plasma-assisted etching).

It is understood that the aspects discussed in relation to the fabrication of a single lens element may apply in a corresponding manner to the simultaneous fabrication of multiple lenses, e.g. on a wafer, which may be stacked together according to a desired optical design. After stacking, singulation may be carried out (e.g., with a dicing process) to convert from wafer-level to individual lens.

The configuration proposed herein addresses the challenge of reducing surface reflection, which may be relevant in several applications, e.g. tracking sensors, mobile devices, endoscopy tests, etc. In absence of any surface treatment there may be a loss of about 4% of incoming light per lens. If each surface of the lens loses that much light, it may become a significant reduction. Furthermore, for certain applications the reflected light may impinge on the sensor and damage the optical quality. In conventional interference-based optical coating a physical vapor deposition (PVD) is carried out to have a multilayer thin film on the optical surface. However, such conventional approach faces the challenge that the coating presents issues at high temperatures. This may be relevant in case of processing steps such as reflow, e.g. at temperatures up to 260° C. to solder the package to a circuit substrate (e.g., a PCB). The mismatch in thermal expansion may lead to cracks in the coating. Anti-reflection structures address this issue. In general, anti-reflection structures change the refractive index in the region, thus providing a localized change, so that when the light hits the surface it sees a change in refractive index and minimizes the reflection. However, forming anti-reflection structures (e.g., nanostructures) directly in the optical surface may also be challenging and, for some lens materials, may not offer sufficient robustness and stability of the anti-reflection capabilities.

With the proposed configuration, an additional layer is used that is dedicated to hosting the anti-reflection structures, so that the process of forming the anti-reflection structures may be standardized for any type of lens and any type of lens material. Illustratively, the formation of the structures is decoupled from providing the lens. The additional layer may be a very thin layer (e.g., with a few tens of microns in thickness) and may be a conformal layer, thus ensuring a uniform shape and thickness are uniform. The anti-reflection structures may then be formed (e.g., etched) in the additional layer, thus independently on the properties of the underlying lens. For example, the lens and the epoxy layer may be formed via optical tooling that allows a precise definition of the shape. A substrate (e.g., a glass wafer) pushes the material (e.g., in liquid form) to comply with the profile, and a curing step solidifies the material to define the lens (first) and the epoxy layer (afterwards). The epoxy layer may formed with the help of WLO techniques (and alignment marks to align the replication site with the lens element) that allow precisely defining the thickness of the epoxy layer. As mentioned, the epoxy layer may be applicable to any type of lens, without affecting the imaging quality. Illustratively, providing an additional layer allows providing anti-reflection structures without having to redesign the base layer.

The following examples pertain to aspects of the present disclosure (e.g., to the optical element 200 and method 400, 500).

Example 1 is an optical element including: a lens element; and an additional epoxy layer disposed on an optical surface of the lens element, wherein the additional epoxy layer includes anti-reflection structures formed in the additional epoxy layer.

In Example 2, the optical element according to example 1 may optionally further include that the anti-reflection structures are etched in the epoxy layer.

In Example 3, the optical element according to example 1 or 2 may optionally further include that the lens element includes or is made of an epoxy material (as other examples, the lens element may include or be made of a glass, a polymer, and the like).

In Example 4, the optical element according to example 3 may optionally further include that the epoxy material of the lens element is different from an epoxy material of the epoxy layer.

In Example 5, the optical element according to example 3 or 4 may optionally further include that the epoxy material of the epoxy layer has a greater etchability compared to the epoxy material of the lens element.

In Example 6, the optical element according to example 5 may optionally further include that the epoxy material of the epoxy layer has a greater etchability compared to the epoxy material of the lens element at least in a plasma-assisted etching process using argon plasma.

In Example 7, the optical element according to any one of examples 1 to 6 may optionally further include an optical substrate; that the lens element is disposed on the optical substrate, and that the optical surface of the lens element faces away from the optical substrate.

In Example 8, the optical element according to example 7 may optionally further include that the optical substrate is or includes a wafer. For example the optical substrate is or includes a glass wafer.

In Example 9, the optical element according to any one of examples 1 to 8 may optionally further include that the epoxy layer has a thickness in the range from 1 μm to 100 μm. For example, the epoxy layer has a thickness in the range from 5 μm to 50 μm.

In Example 10, the optical element according to any one of examples 1 to 9 may optionally further include that at least one anti-reflection structure has a height in the range from 100 nm to 500 nm. For example, at least one anti-reflection structure has a height in the range from 200 nm to 300 nm.

In Example 11, the optical element according to any one of examples 1 to 10 may optionally further include that the epoxy layer includes or consists of a bisphenol-based material, an aliphatic-based material or a combination of both, and that the lens element includes or consists of an epoxy-based material, an acrylic-based material, or a cycloolefin polymer based material.

In Example 12, the optical element according to any one of examples 1 to 11 may optionally further include that the anti-reflection structures are configured to provide anti-reflection in the infrared or near-infrared wavelength range. As another example, the anti-reflection structures may be configured to provide anti-reflection in the visible range.

In Example 13, the optical element according to any one of examples 1 to 12 may optionally further include that the epoxy layer is conformally formed on the optical surface of the lens element

In Example 14, the optical element according to any one of examples 1 to 13 may optionally further include that the epoxy layer fully covers the optical surface of the lens element.

In Example 15, the optical element according to any one of examples 1 to 14 may optionally further include that the optical element is a wafer-level optical element. Illustratively, the optical element may be manufactured by wafer-level process.

In Example 16, the optical element according to any one of examples 1 to 15 may optionally further include that the anti-reflection structures are configured to provide gradual change of refractive index from 1.0 (refractive index of air) to the refractive index of the epoxy layer.

In Example 17, the optical element according to any one of examples 1 to 16 may optionally further include that the anti-reflection structures are or include pit-like features or rod-like features formed in the epoxy layer.

Example 18 is an optical stack including: a plurality of optical elements configured according to any one of examples 1 to 17; wherein the plurality of optical elements are disposed to form a stack of optical elements.

Example 19 is a method of fabricating an optical element, the method including: providing a lens element; providing an epoxy layer on an optical surface of the lens element; and forming anti-reflection structures in the epoxy layer.

In Example 20 the method according to example 19 may optionally further include that providing a lens element includes: depositing epoxy material in a replication tool shaped according to a profile of the lens element; contacting the replication tool with an optical substrate; and curing the epoxy material to form the lens element on the optical substrate.

In Example 21 the method according to example 20 may optionally further include that providing the epoxy layer on the optical surface of the lens element includes: depositing epoxy material in the replication tool shaped according to the profile of the lens element; contacting the replication tool with the optical substrate to allow the epoxy material of the epoxy layer to distribute over the optical surface of the lens element; and curing the epoxy material to form the epoxy layer on the optical surface of the lens element.

In Example 22 the method according to any one of examples 19 to 21 may optionally further include that forming anti-reflection structures in the epoxy layer includes etching the epoxy layer to form (e.g., etch) the anti-reflection structures in the epoxy layer.

In Example 23 the method according to example 22 may optionally further include that etching the epoxy layer includes carrying out a plasma-assisted etching of the epoxy layer.

In Example 24 the method according to any one of examples 19 to 23 may optionally further include any feature of the optical element according to any one of examples 1 to 17.

The term “control circuit” (or processing circuit) as used herein may be understood as any kind of technological entity that allows handling of data. The data may be handled according to one or more specific functions that the control circuit may execute. Further, a control circuit as used herein may be understood as any kind of circuit, e.g., any kind of analog or digital circuit. A control circuit may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

### List of Reference Signs

100 Imaging device
102 Image sensor
104 Optical module
106 Processor
108 Optical element
108b Optical element
110 Field of view
112 Lens portion
114 Anti-reflection structures
120 Picture
122 Wrinkles
130 Graph
132 Pre-reflow data
134 Post-reflow data
200 Optical element
202 Lens element
204 Epoxy layer
206 Anti-reflection structures
208 Curved surface
210b Microscope picture
210c Microscope picture
212 Optical substrate
250 Microscope picture
252 Lens element
254 Optical substrate
256 Epoxy layer
300 Optical stack
302-1 First optical element
302-2 Second optical element
302-3 Third optical element
304 Support structure
400 Method
410 Method step
420 Method step
430 Method step
500 Method
502 Lens material
504 Replication tool
506 Substrate
508 Lens element
510 Method step
512 Epoxy material
516 Conformal layer
520 Method step
530 Method step
540 Method step
550 Method step
560 Method step
570 Method step
580 Method step

1. An optical element (200) comprising:
a lens element (202) configured to implement a lens function,
wherein the lens element (202) comprises an epoxy material; and
an additional epoxy layer (204) disposed on an optical surface (208) of the lens element (202),
wherein the additional epoxy layer (204) includes anti-reflection structures (206) formed in the additional epoxy layer (204).

2. The optical element (200) according to claim 1,
wherein the anti-reflection structures (206) are etched in the additional epoxy layer (204).

3. The optical element (200) according to claim 1,
wherein the lens element (202) consists of an epoxy material.

4. The optical element (200) according to claim 1,
wherein the epoxy material of the lens element (202) has lower etchability compared to the epoxy material of the additional epoxy layer (204).

5. The optical element (200) according to claim 4,
wherein the epoxy material of the lens element (202) has a lower etchability compared to the epoxy material of the additional epoxy layer (204) at least in a plasma-assisted etching process using argon plasma.

6. The optical element (200) according to claim 1, further comprising:
an optical substrate (212);
wherein the lens element (202) is disposed on the optical substrate (212), and
wherein the optical surface (208) of the lens element (202) faces away from the optical substrate (200).

7. The optical element (200) according to claim 1,
wherein the additional epoxy layer (204) has a thickness in the range from 1 μm to 100 μm.

8. The optical element (200) according to claim 1,
wherein the anti-reflection structures (206) are configured to provide anti-reflection in the visible wavelength range and/or infrared wavelength range and/or near-infrared wavelength range.

9. The optical element (200) according to claim 1,
wherein the additional epoxy layer (204) is conformally formed on the optical surface (208) of the lens element (202).

10. The optical element (200) according to claim 1,
wherein the optical element (200) is fabricated via wafer-level processing.

11. A method (400) of fabricating an optical element, the method comprising:
providing (410) a lens element configured to implement a lens function,
wherein the lens element comprises an epoxy material;
providing (420) an epoxy layer on an optical surface of the lens element; and
forming (430) anti-reflection structures in the epoxy layer.

12. The method (400) according to claim 11,
wherein providing a lens element comprises:
depositing lens material in a replication tool shaped according to a profile of the lens element;
contacting the replication tool with an optical substrate; and
curing the lens material to form the lens element on the optical substrate.

13. The method (400) according to claim 12,
wherein providing the epoxy layer on the optical surface of the lens element comprises:
depositing epoxy material in the replication tool shaped according to the profile of the lens element;
contacting the replication tool with the optical substrate to allow the epoxy material of the epoxy layer to distribute over the optical surface of the lens element; and
curing the epoxy material to form the epoxy layer on the optical surface of the lens element.

14. The method (400) according to claim 11,
wherein forming anti-reflection structures in the epoxy layer comprises etching the epoxy layer to form the anti-reflection structures in the epoxy layer.

15. The method (400) according to claim 14,
wherein etching the epoxy layer comprises carrying out a plasma-assisted etching of the epoxy layer.
